(19) United States
(12) Patent Application Publication
(10) Pub. No.: US 2005/0120050 A1
(43) Pub. Date: Jun. 2, 2005

(54) Enhanced storing of personal content

(76) Inventors: Andreas Myka, Helsinki (FI); Jukka Yrjanainen, Ylojarvi (FI); Marc Gelcgon, Luce/Loire (FR)

Correspondence Address: PERMAN & GREEN, 425 POST ROAD, FAIRFIELD, CT, 06824, US

(21) Appl. No.: 10/502,275

(22) PCT Filed: Mar. 28, 2002
(86) PCT No.: PCT/FI02/00277

(51) Int. Cl. G06F 7/00

(52) U.S. Cl. 707/104.1

(57) ABSTRACT

The invention relates generally to the access to and the creation of content in the context of a mobile communications system and more specifically to archiving personal content of mobile users and for providing this content to mobile users in the most flexible and personalized ways. The core of the invention is how personal content acquired by the user may be further enhanced and stored in a safe box-like remote repository for future purposes. At least one remote data repository is assigned for the use of mobile terminals. Personal content is acquired and stored in the mobile terminal. Selected personal content is then transferred between the storage means and the remote data repository through the telecommunications system, the means to include predetermined criteria, the fulfillment of which initiates the transfer.

### FIELD OF THE INVENTION

The invention relates generally to access to and the creation of content in the context of a mobile communications system. More specifically, the invention relates to a method and system for archiving the personal content of mobile users and for providing this content to mobile users in the most flexible and personalized ways. The content refers here to any multimedia data, including e-mails, text messages, images, audio files, calendar entries, log information, and e-commerce data. The invention relates to acquiring personal content on a mobile terminal, storing it in a remote repository, and retrieving it from the remote repository.

### BACKGROUND OF THE INVENTION

The strong growth in the number of Internet users and services provided through the Internet has been one of the most remarkable phenomena in communications in recent years. Another current trend is the strongly increasing use of various mobile terminals, such as laptops, PDA (Personal Digital Assistant) equipment, and intelligent telephones.

These two rapidly evolving network technologies, wireless communication and the Internet, are gradually converging. So far this converging development has been progressing rather slowly, since most of the technology developed for the Internet has been designed for desktop computers and medium or high bandwidth data connections. It has, therefore, been difficult to introduce the IP-based (IP=Internet Protocol) packet services to the mobile environment, which is characterized by less bandwidth and poorer connection stability in comparison to fixed networks, and where the terminals have many fundamental limitations, such as smaller displays, less memory, and less powerful CPUs, as compared to fixed terminals. However, the development of IP-based packet services for the mobile environment will occur at an increasing rate in the foreseeable future. This is partly due to the demand created by the market and partly due to the evolvement of new technologies designed to meet the various requirements of mobile networks, such as sufficient quality of service and data security. The increasing market demand is based on the rapid increase in the popularity of the Internet: Internet users are often also mobile subscribers and thus may also want to use in their mobile terminals the services familiar to them from the Internet environment. This commercial demand in turn enables investments necessary for the development of mobile services. The said new technologies include GPRS (General Packet Radio Service) and WAP (Wireless Application Protocol), for example. GPRS aims at providing high-quality services for GSM subscribers by efficiently utilizing the GSM infrastructure and protocols. WAP, in turn, defines a set of standard components enabling communication between mobile terminals and servers providing service in the network. WAP utilizes proxies that connect the wireless domain with the WWW domain.

The above-described development will in the near future turn the mobile terminals into versatile multimedia tools. In addition to the features that current mobile terminals include, these future terminals will have a variety of sensors for multimedia data, for example, such as a camera and a location sensor. Besides the technical feasibility of constructing such devices, it is important that the users get a clear benefit from using such terminals and that the telecommunications system to which the terminals belong does not pose restrictions on the efficient use of the devices.

In comparison to already existing multimedia tools, such as digital cameras, the recent development of mobile terminals can offer a variety of new multimedia related services, as the technological solutions used by the mobile terminals and the mobile network infrastructure enable various possibilities not seen before. On the other hand, the interconnected networks, such as the Internet, act as enabling factors as well. The possibilities thus created have so far mostly been unexplored, leaving space for innovative practices and new service models within the communications industry.

One example of the immense possibilities mentioned above is sometimes referred to with the general term metadata. Metadata itself is data about data, defining new relations inside a batch of data, or building new ontological layers. The existing solutions to deploy metadata are still far away from effectively utilizing all the possibilities offered via mobile terminals. Some prior art examples to refer to here are described in more detail in U.S. Pat. No. 6,282,362 and European patent application 1 004 967. Typically, images are an important type of multimedia information, and metadata may indicate the position where an image was taken or information describing the subject of an image.

Some idea of prior art services necessary for the future mobile environment can in principle be found from the international publication WO 00/57315 and U.S. Pat. No. 6,105,042. The idea of eliminating limitations posed by the finite terminal memory and low bandwidth connection between the mobile terminal and the mobile network implies some straightforward solutions for a few typical cases, which are presented in the references.

However, none of the solutions referred to is capable of offering a total solution for a mobile terminal user with respect to the flexibility of storing, transfering, and using the personal content acquired by the user or the terminal.

Because all possible solutions have been developed from a narrow point of view and aimed for resolving a single problem at a time, the demands raised by the users, as well as the possibilities offered from the versatility of the systems used, have largely not yet been met.

The objective of the invention is to introduce a novel concept for providing the users with an enhanced method and system for storing personal content. The dependent claims describe some aspects of the invention.

### SUMMARY OF THE INVENTION

The objective of the invention is to accomplish a solution which allows efficient and user-friendly mechanisms for providing personalized services to the mobile users in the context of their personal data. This objective is achieved with the solution defined in the independent patent claims. The core of the invention is the mechanism how personal content acquired by the user may be further enhanced and stored in a safe box-like remote repository for future purposes.

According to the invention, access to stored objects can be provided for mobile users in the following manner. First, at least one remote data repository is assigned for the use of each of the terminals, the repository being operationally connected to a telecommunications network for storing personal content. Personal content is acquired by the mobile terminal, which has been adapted to be in wireless communication With a telecommunications network. The personal content acquired is stored in the mobile terminal and then selected personal content is transferred between the storage means and the remote data repository through said telecommunications system, the means including predetermined criteria, the fulfillment of which initiates said transfer.

Stored personal content is accessed from the mobile terminal by i) requesting an object including stored personal content from the mobile terminal, ii) receiving a predetermined return code if the requested object is not located in the mobile terminal, and iii) further requesting the object from the remote data repository if the return code indicates that the requested object is not located in said storage means.

In accordance with one aspect of the present invention, a server is connected to said remote data repository for managing objects and information extracted and/or generated based on said objects, the objects and information to include the personal content stored in the remote data repository.

In accordance with one aspect of the present invention, said information related to said object is updated to indicate that the object has been requested by the mobile terminal. Then the updated information is stored in the remote data repository.

In accordance with one aspect of the present invention, a register is updated, the register to include objects and/or extracted data stored at least at one point in time in the mobile terminal storage means. In accordance with another aspect of the present invention, this may include marking deleted and/or transferred objects and/or extracted data that has been transferred to the remote data repository.

### BRIEF DESCRIPTION OF THE DRAWINGS

The invention is described more closely with reference to FIG. 2-15 of the accompanying drawings, in which

FIG. 1 illustrates a mobile network wherein prior art services are provided to the users,

FIG. 2 is a schematic diagram of a system which can be used to provide enhanced data storage capabilities according to the invention, the diagram describing network elements favorable when implementing some embodiments of the invention,

FIG. 3A shows sample content of a software block of a user terminal 100 which can perform some tasks described in a preferred embodiment,

FIG. 3B illustrates the hardware block of a user terminal 100,

FIG. 3C illustrates the contents of the storage means of a user terminal 100,

FIG. 4A illustrates the functional blocks of the software in the MD DB server 240,

FIG. 4B represents the contents of an exemplary remote data repository 242,

FIG. 5 is an example of the functional blocks of the upload registry 280,

FIG. 6 is a diagram showing examples of tasks performed in the terminal prior to the transfering of data, messaging related to the transfer of the content to the remote data repository, waking service applications, deleting transferred data, and generating data at least partially based on the transferred content,

FIG. 7 is a diagram of exemplary terminal hardware which is detecting new objects,

FIG. 8 is a diagram of an exemplary terminal daemon 326 which wakes up the right terminal application,

FIG. 9 is a diagram of an exemplary terminal application which can extract data from acquired objects and register objects and data ready for transfer,

FIG. 10 is a diagram showing a possible operation model of an upload registry 280 run by the network operator, for example,

FIG. 11 is a diagram of an exemplary reachable terminal daemon 322 in the network which can initiate applications when requested from the network,

FIG. 12 is a diagram showing a possible operation model of MD application 334 which can, for example, take care of uploading the stored personal content into the remote data repository,

FIG. 13 is a diagram showing an exemplary operation of an MD DB server 240,

FIG. 14 is a diagram showing exemplary operation of an application server 250,

FIG. 15 is a diagram showing exemplary operation of a deletion application 324 run in the mobile terminal.

### DETAILED DESCRIPTION OF THE INVENTION

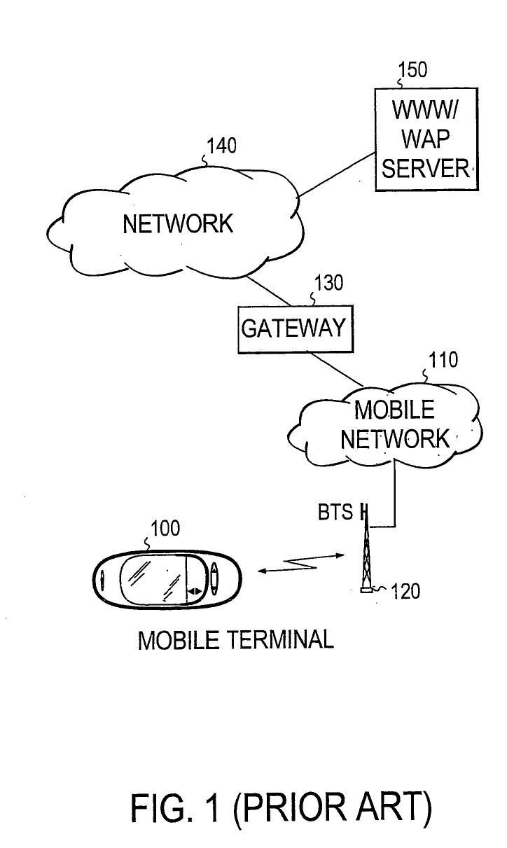

FIG. 1 shows a schematic diagram of a prior art mobile network 110 connected to a communications network 140 such as the Internet via a gateway element 130. These kinds of arrangements are widely used to provide services to user terminals, of which one mobile terminal 100 is illustrated in the figure. Mainly, the terminals are in connection with the mobile network via base transceiver stations 120, which in plurality comprise the radio access network of the network 110.

Many services which are provided to the users are produced in different servers 150, an example of which is a WWW/WAP server illustrated in FIG. 1. The servers 150 are mostly connected directly to the Internet and provide many different services, such as following the stock exchange rates in accordance with criteria supplied by the user subscribing to the service in question. When the server detects that some criterium is fulfilled, it notifies the user by sending a message. Further, services such as directory services or anonymous chat services may be implemented using a server system similar to the example above.

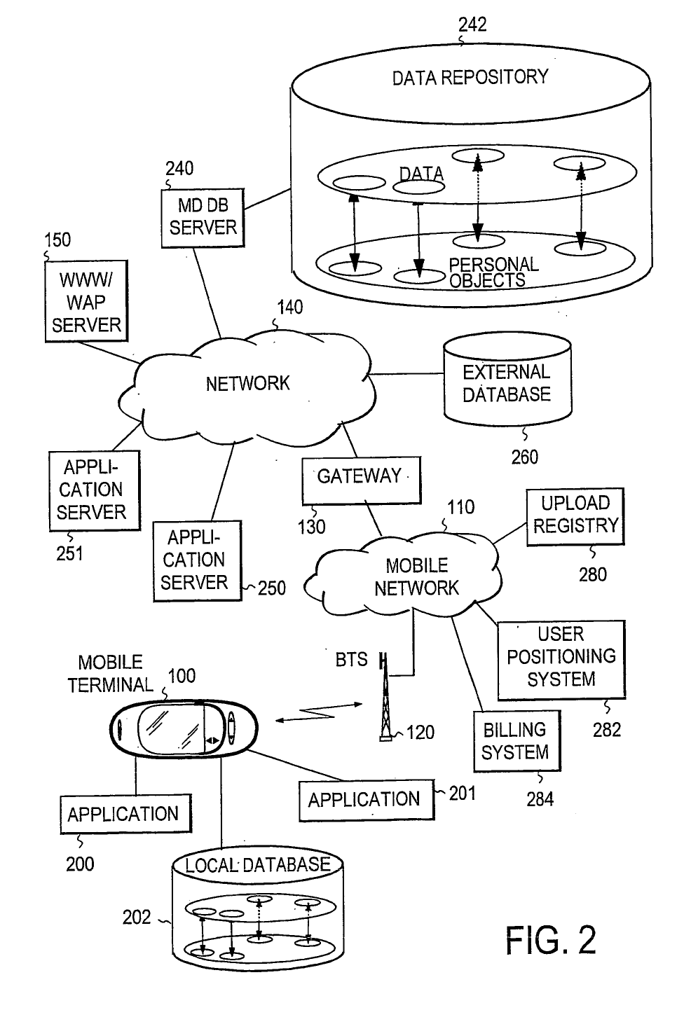

FIG. 2 shows some aspects favorable for designing a network architecture in view of the recent development trends. Because the mobile terminals have been evolving towards versatile multimedia tools, they are supplied with some applications. Examples of typical applications are, for example, camera user interface and data storage logic. The application data which forms the personal content is stored in a local database 202, which can in practice be a memory chip, a local disk drive, or something else providing the user with reliable means for storing information. According to the invention, the mobile terminal 100 is provided with a plurality of applications, of which two examples 200 and 201 are presented in FIG. 2. The applications have means to access this content and, if necessary, to perform simple analysis tasks or to transfer the content to a remote data repository 242. Further, the system comprises an MD DB server 240, which corresponds to a Media Diary Database server. The MD DB server has several functionalities, and it not only controls access to the remote data repository but performs other tasks very similar to how a user uses a traditional diary and notebook. The Media Diary (MD) system is the multimedia equivalent to the traditional server. Its parts may include an MD DB server 240, an MD application 334 in the mobile terminal, various applications, and some other parts described below in more detail. The different system parts are intended to work together so that the strengths of each component may be used in the best way. The MD DB server does not need to be an extraordinary server; a commonly used server will do. The definition MD DB is more inclined to description of the purpose for using the server to access a database. Thus the database corresponds to the MD DB, which is a remote repository where objects of personal content may be stored, for example.

Further, the system comprises a plurality of different application servers 250 and 251. It is to be noted that the servers need not be separate elements, but that in some cases the applications may be stored in the MD DB server as well. The same applies to the remote data repository 242, which can be included in the MD DB server. According to one aspect of the present invention, the MD DB system includes a server, a data repository, and means to execute some applications stored somewhere in the network. The purpose of the MD DB system is, on the one hand, to provide the user with reliable data storage, and on the other hand, with a possibility to easily gain the advantages of personalized services.

The system has access, if necessary, to an external database 250. This can easily be implemented using the Internet or some other communications network.

In order to archive this data, the user data can be transferred from the restricted and expensive local data storage 202 to the bigger and cheaper remote data repository. Data that has been archived can then be (temporarily) removed from the local data storage 202 and the valuable storage space can be reused for data that is to be considered more needed at a specific time. For the uploading task an upload registry 280 may be involved. An example of a possible structure of the upload registry is described in more detail below, but the upload registry may include some of the following: Reading and/or receiving identifiers identifying data to be uploaded, or mobile terminal identification information (such as the phone number or IP address of the terminal) having items to be uploaded. The upload registry may monitor the status of the register and check when a predefined criteria is met, such as when the gross size of the data to be transferred exceeds some limit, or the transfer price per data unit drops below a predefined threshold, and so on.

The upload registry may also include means for receiving personal content to be transferred to the remote data repository, or means for sending a request (or for waking up a terminal application) to make a connection either to the upload registry or to the MD server or even directly to the MD DB.

Typically, modern mobile networks also include other practical means, such as a user positioning system 282 and a billing system 284. Some components such as the positioning system 282 or the external data-base 260 are already known from prior art, but they are presented here only with reference to FIG. 2 because some aspects of the present invention enhance the use of these systems in the manner described in the patent claims.

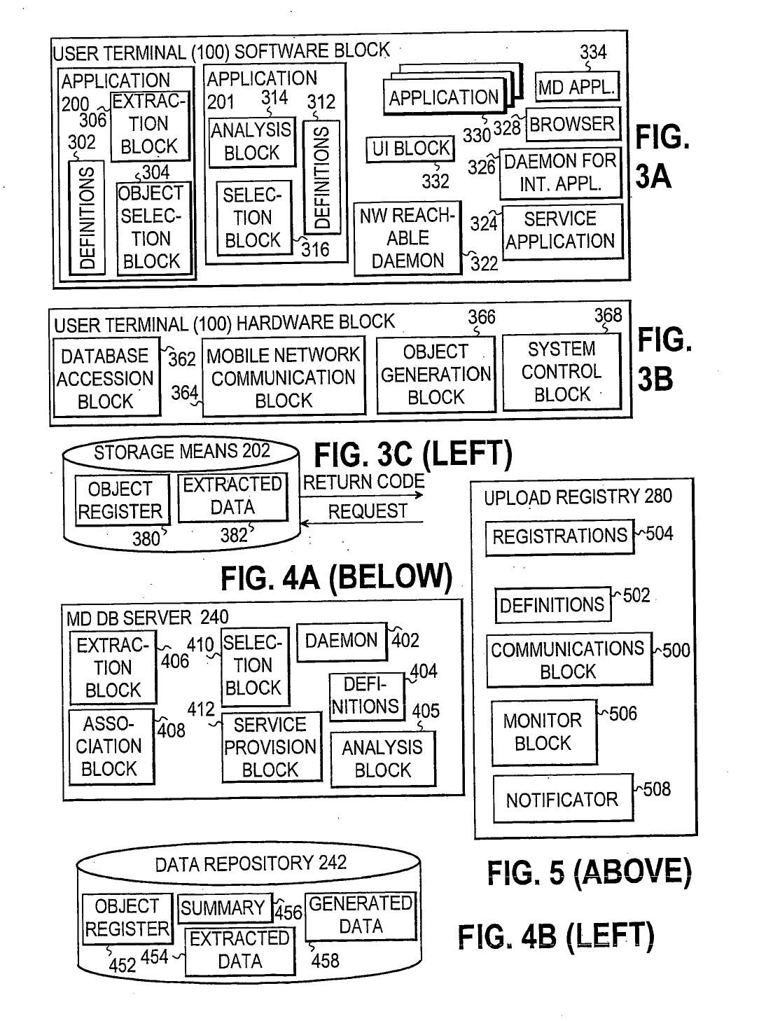

FIG. 3A shows a schematic diagram of a software block of the user terminal 100. An application 200 which can be used to extract data from an object includes definitions 302 which define some settings, such as on which kind of objects the application is capable of working, then possibly some adjustable parameters, such as what system (coordinate system, symbolic/address system, etc.) is used for location information of the user and so on. An object selection block 304 may be used to select objects on which the extraction block 306 is to perform data extraction and so forth. Application 201 comprises definitions 312 similar to definitions 302, as well as the analysis block 314 and selection block 316.

The mobile terminal may comprise a plurality of other applications 330 as well, in addition to or instead of applications 200 and 201. The mobile terminal usually has some form of user interface Ul block 332. The role of the Ul block is to provide the user with a convenient way to set his/her preferences and to monitor the operation of the terminal software SW and hardware HW, and so forth. According to one aspect of the present invention, the user terminal may have a Media Diary MD 334 application as well. The MD application may even correspond to a sort of operating system, such so that via the Ul block the MD application rules the applications 200, 201, 330 and so on. Typically, some mobile terminals also comprise a browser 328, which is one solution for getting the needed updates for the MD application and other applications.

The MD application 334 is intended to convert the user terminal into a versatile multimedia tool capable of providing special services related to the personal content acquired by the user. Such services are various, but in view of the enhanced data storage functionality, basically the services handle the association of metadata related to personal content or data which has been extracted from said personal content, to the extraction of information from said content, to the transference of the content to and from the remote data repository, to the accessing of said stored content, and to performing some actions like deleting obsolete or outdated information from the user terminal and so forth. In principle, one goal of the MD application is to provide the user with a user interface and means to set-up all the definitions and operating models related to these functionalities, thus acting as a sort of front end. Even if the tasks described above are performed by dedicated program applications, some of which reside in the mobile terminal and some in a networked computer or server, and even if they are adapted to be independent in the sense that this special MD application is not absolutely necessary, it is under current development work in order to offer the user a single point of control and use.

Further, the user terminal has two different daemons available. The network reachable daemon 322 takes care of connections initiated from the mobile network 110 or some other communications network 140, such as the Internet. The daemon for internal application 326 acts as a middleman between the hardware and software. It may also monitor the action of other applications and perform some predetermined tasks when it considers them necessary.

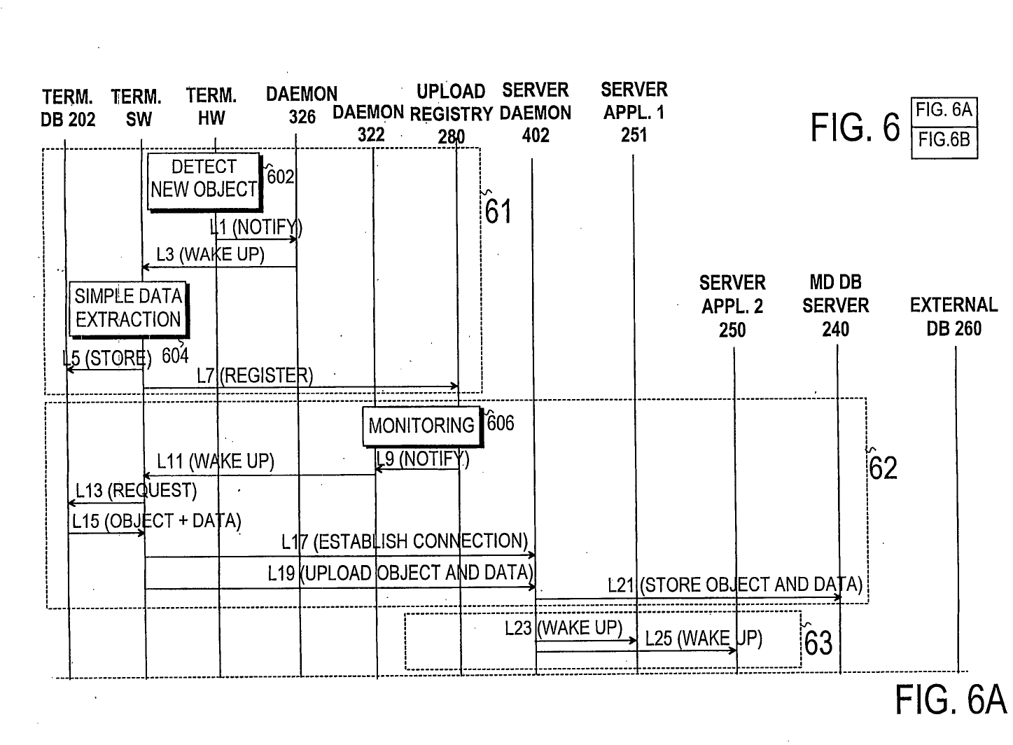

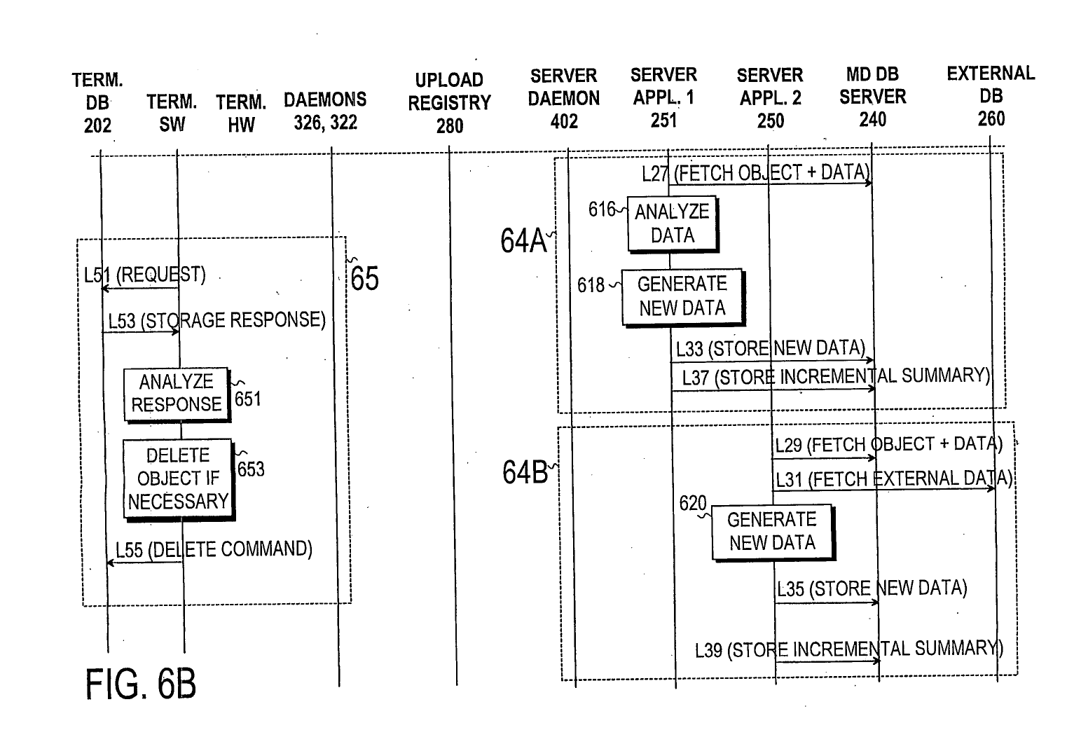

The reasoning behind at least one daemon with this kind of multi-functional property will be explained in more detail with reference to FIGS. 6, 8, and 11, and similarly, the reasoning behind the different applications stored in the mobile terminal is discussed below with reference to FIGS. 6, 9, 12, and 15.

FIG. 3B is a schematic block diagram of the hardware block of the user terminal. In this context the hardware is considered functionally different from the storage means 202, but it is to be understood that it is also possible to implement both functionalities together in the hardware part, basically because the physical realization of the storage means always requires some sort of hardware. The hardware block has a database accession block 362 with means to perform operations on the storage means 202. Then the hardware block has means in the mobile network communication block 364 to be in communication with the mobile network 110 and with its base transceiver stations 120. Further, the object generation block 366 can assist in generating personal content objects, generated using or via some part of the hardware be they digital images, calendar entries, speech or text messages. The system control block 368 supervises the system and keeps the different functional blocks in the hardware running.

FIG. 3C is a simplified block diagram of the local storage means 202 of the mobile terminal. First, the storage means have an object register 380 which is intended for storing personal content. As discussed below, the object register indicates, on one hand, the objects which are available locally and the objects which have to be retrieved from the remote data repository, on the other hand. In response to a query requesting an object, the local storage means returns a code indicating that the object is not available locally and has to be fetched from the remote data repository. A code may indicate which data repository the object is to be retrieved from especially if there is a plurality of remote repositories available such as if the user is roaming in a different mobile network, abroad, for example. Secondly, there is also the extracted data block 382 for extracted data. Typically, such data extraction may be performed, for example, in the extraction block 306 of some application.

FIG. 4A shows a simplified structure of the MD DB server 240. The MD DB server 240 is the gatekeeper for personal content. This means that it is the element where access restrictions and other confidentiality issues are considered. When requesting a service from the MD DB server, the user can set different access policies for different parts of the data. In addition, access to a specific type of content may be restricted for some service and service application, whereas some other application may access that same data. Also, policies such as read only, read only at the MD DB server, or similar solutions may be implemented. The purpose of the latter example is to allow third parties to supply various analysis and service applications while maintaining the privacy of the user by disallowing the misuse of confidential or strictly personal information. In other words, the MD DB server is partially intended for managing objects and information extracted and/or generated from said objects, the objects and information being the personal content stored in the remote data repository.

One aspect in the handling of confidentiality issues is discussed below with reference to FIG. 12. Preferably, the server has a daemon 402 to activate the correct service provision block 412. For this purpose both the daemon 402 and the service provision block 412 have definitions 404 which contain, for example, information on requirements posed by the services and different options for service requests. In order to complement this task, the MD DB server may also have data extraction means in an extraction block 406. The extracted information must be associated to the corresponding personal content or content object. Therefore, the system also has association means in the corresponding association block 408. Due to the possibly large number of personal content items, the system may further comprise selection means in a selection block 410 responsible for the appropriate selection of personal content, either in the form of an object or extracted data, during the provision of the personalized service.

FIG. 4B is a schematic block diagram of the functional blocks of an exemplary remote data repository 242. First of all, the repository contains personal content in the form of objects in the object register 452. The repository may also contain a summary or several summaries 456 of the content stored in the register. Data extracted 454 from the objects and also data generated 458 by some services may be a part of this content. The general term “services” is here to be understood as provisions of means for analysis and the combining of information so that the personal content of the user may be enhanced at least in some manner. It is to be noted that the services may be provided in the service provision block 412 of the MD DB server, in a separate application server 250 or 251, or both.

The storage means 202, together with user terminal 100 hardware HW and software SW blocks, have a file system. The file system may be arranged so that the HW/SW block requests an object including stored personal content from the storage means in the mobile terminal. If the requested object is not located in said storage means, the system, in practice the HW/SW block, may be further arranged to request the object from the remote data repository. This may be implemented so that there is a list of locally available objects in the terminal, and a list of remotely available objects, i.e. objects that have already been transferred to remote data repository 242. If the object is located in the remote repository, instead of delivering the object the local storage means 202 may return a return code, in a predetermined format. This operation may be a result of a read request for the object.

The production or provision of services may also be performed in steps in such a way that some parts of the service are generated in one server and some other parts in another. It is clear that the design of the services gets a bit more complicated when the number of servers involved increases. Finally, the service may be combined from several parts to form the complete enhanced content, and the combination can be performed either at some server in the system or at the user terminal. In the latter case the combination of the content from parts may be virtual so that the user cannot recognize how the different parts of the content are actually produced.

FIG. 5 is a block diagram of an upload registry 280. The upload registry is connected to the external world via a communications block 500 which receives messages (L7) intended for the upload registry and sends messages to user terminals, for example. The upload registry 280 may include definitions 502, such as access policies, lists of allowed users and their services, pricing policies and cost structures of the mobile network, and so on. The upload registry may also contain registrations 504, which are on a per user basis and show the personal content objects registered for uploading, for example. The upload registry may be used for downloading files as well. The monitor block 506 monitors the conditions for each user, the conditions preferably being stored in the definitions. When a predetermined condition is met, such as some threshold value for transfer price per data unit, the transfer may be initiated by informing the notificator 508. The notifficator generates a message L9 to be sent to the mobile terminal daemon 322 and then passes it to the communications block 500 to be delivered further.

FIG. 6 shows various aspects of the present innovative concept. The presented mechanisms. provide significant advantages in view of user interface and ease of use, and also take into account cost efficiency and radio network utilization considerations when providing a mobile user with storing and content enrichment services.

First, the dashed box 61 illustrates some tasks prior to the transfer of the personal content. When the user or the terminal acquires some personal content, it is detected (step 602) by the hardware 200, and the hardware notifies (message L1) the terminal daemon 326 provided within the terminal. The terminal daemon is a terminate-and-stay-resident-type application which wakes up when receiving a notification. The terminal daemon analyzes the notification by, for example, checking which kind of content was acquired, and then it decides, partially based on the software capabilities and settings of the terminal, if an application 201 in the terminal is to be woken up by sending message L3.

The terminal application 201 is loaded or activated in the terminal. If the application requires a significant computational effort, the terminal may run it with a lower priority or it may wait until the terminal is in an idle state in order to avoid reducing the comfort of use in an annoying way. The application may extract some data from the personal content. For example, if the content in question is a digital image, it may extract (step 604) parameters such as the time and date of taking the image, exposure and flash settings, and so forth. It may also request some other information related to the content, such as positioning information. If the positioning information describing the user's past behavior is stored in a location history database, the information may be requested from there. Alternatively, the positioning information may be requested from a mobile network positioning system 282. Also, the data extraction step 604 may include reading values of a register in the terminal the cell identity of the current cell of the terminal, location area information, and so on.

Some other ways to perform the detection and simple data extraction steps may be realized, for example, by implementing the system in such a way that a user indicates his/her wish to use some personalized service at a given moment by simply pressing an activation button in his/her mobile terminal. The pressing of the button may initiate the application responsible for of collecting certain information and, for example, initiate some other applications, such as a digital camera user interface. Thus, when the user presses the button, the terminal system having a digital camera functionality may request the user to take a picture. Then the information relevant to the taking of the picture is extracted.

What kind of information is marked as being related depends on the reliability of the algorithm that identifies two pieces of information as related and on the usefulness of this relationship to the user; the latter is decisive because the storing of each relationship takes up valuable memory space. As all data is personal, one heuristic algorithm may be applied according to which all data that originated at the same time is interconnected. The concept of simultaneity may be further narrowed down on the basis of user preferences and system findings. For example, in some cases a time difference of half an hour between the origins of two objects might still be considered simultaneous, whereas in other cases a gap of five minutes might already be too large. This basic approach can be varied, e.g. according to the types of generated data and, of course, according to the connecting concept; for example, instead of time, location can be used. The information about the relationships to other data is considered to be part of the extracted data. This kind of relationship may be regarded as the association of different objects.

The extracted information, including the information on relationships between pieces of data, is preferably stored (message L5) in the terminal database 202. The terminal database may be a register residing on a memory chip, such as the random access memory of the subscriber identity module, or a terminal memory, or a magnetic device such as a hard disk. Further, the terminal application may notify the upload registry 280 of the file transfer system of the operator to indicate that new content has been acquired and that the content is ready for uploading (message L7). Together with this notification, there may be an indicator of the current status of the terminal device, such as the available memory, the estimated charge status of the mobile terminal battery, and so on.

The dashed box 62 shows how the actual transfering of personal content is performed. Indeed, the transfering can be done in many other ways as well, but the inventive concept described herewith is believed to offer significant advantages over the prior art data transfer systems, such as a mobile-oriented circuit-switched packet data connection or a normal packet-switched packet data connection well known in the art. The ideas of automating some tasks, delaying the actual transfer until predefined criteria are fulfilled, etc., as well as the mechanism whereby the transfer is initiated in the upload registry are believed to be inventive.

In step 606 the upload registry 280 monitors the indicators sent by the mobile terminal. It may, for example, take cost efficiency or radio network usage considerations into account. This means that the uploading of the personal content is initiated when the radio network load drops under a predefined threshold, in terms of transfer price per unit of data, relative usage capacity, or available bandwidth. Also, the pricing of the data transfer may be included in such a way that the transfer is preferably performed only during off-peak traffic hours. However, there may be some specific criteria which trigger immediate transfer, but these considerations are not discussed here.

When the conditions for the uploading are met, the upload registry notifies a terminal daemon 322 by sending a notification message L9. The terminal daemon 322 is a functional unit separate from the terminal daemon 326, in the sense that the terminal daemon 326 is invocable from the applications in the mobile terminal whereas the terminal daemon 322 accepts extenal notifications. This is mainly because of security considerations, because whereas the part of the application invocable by the former daemon 326 has access to practically all information available in the terminal, the part of the application invocable by the latter daemon 322 has access to only part of the files in the terminal data storage 202.

After receiving notification L9, the daemon wakes up the terminal application 201 defined in the daemon settings (message L11). This application may be different from the application 201 referred to earlier, but it can also be implemented using modular programming techniques to restrict the access to information from the corresponding parts as well. The terminal application 201 requests (message L13) data from the terminal data storage 202, for example, reads the terminal memory, and receives the object in a message L15 including personal content and data extracted from it.

After retrieving the object and data, the terminal application establishes (message L17) a connection to server daemon 402 in order to upload the object and data (message L19). The server daemon stores the uploaded content by sending it (message L21) to the MD DB server 240, which further stores it in the remote data repository. According to one aspect of the implementation, it is preferable that there is feedback from 240 to 201 and/or 202 showing that the object has been correctly stored, so that objects not correctly stored are not accidentally erased.

The dashed box 63 shows an example of tasks possible after transfering the content and storing it in the remote data repository. The server daemon wakes up different applications if necessary. For example, an analysis application running in the application server 251 may be called by sending a wake-up call L23, and a content combination application may be invoked by sending another wake-up call L25. In order to facilitate this, the MD DB server 240 may inform the server daemon 402 of the services subscribed to after they have been requested. This way the server daemon may send the wake-up requests L23 and L25 directly to the applications, and it is not necessary for the MD DB server to perform this task.

There may also be a plurality of applications. In the dashed boxes 64A and 64B, two different kinds of applications are presented schematically. The real applications are basically applications having characteristics in common with either one or both of these two types.

The dashed box 64A shows some exemplary tasks possibly required for enabling the operation of the application server 251. As already noticed with reference to the dashed box 63, the message L23 which acted as a request for server application 251 was received at the server application 251. In this case the message L23 included either the identity of the user requesting the service or the identity of the object to be used for the service, which in this case is generating new data.

The object is fetched from the MD DB server by sending a message L27. The object could be fetched from the MD DB as well, if desired, but this example is solely to be understood as an enabling example and not as restrictive in any sense. After the object has been retrieved, it is analyzed in step 616, and at least partially in response to said analysis step, new data is generated in step 618. The new data is then stored by sending it in a message L33. In the MD DB server there may also be an incremental summary. This must be updated, i.e. the operations performed on the data, and possibly also some results of the analysis can be described. The summary is stored by sending an update request L37 to the MD DB server 240.

In the dashed box 64B, another service application 250 performs similar tasks. This application has been woken up by a message L25. It retrieves an object and data by requesting (message L29) them from the MD DB server 240. Then it fetches (message L31) external data from an external database 260. It is to be noted that the retrieved data L29 does not necessarily need to be analyzed any more because the application may have got the information as to what it is about in the original notification L25 from the server daemon 402.

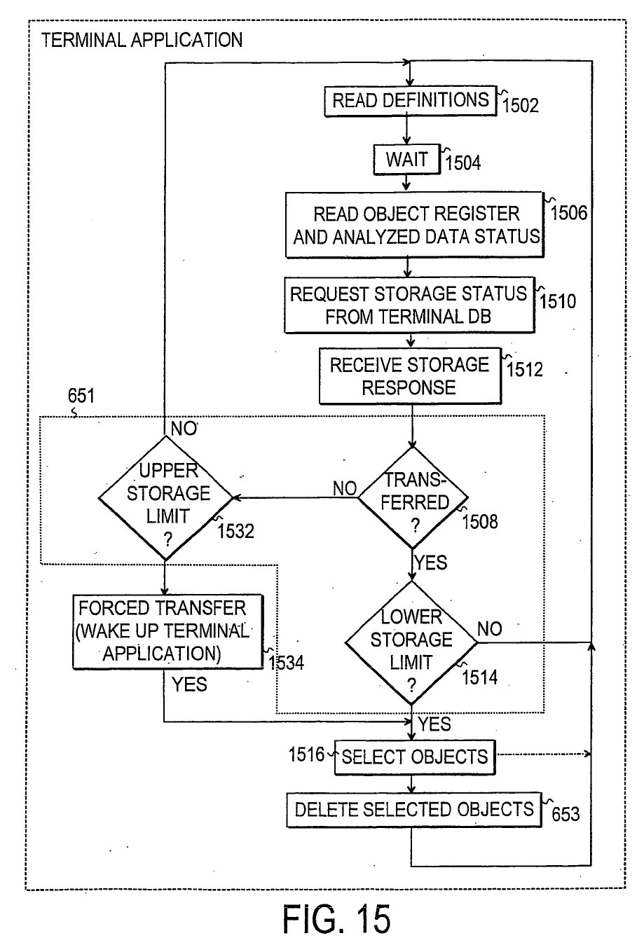

The dashed box 65 which is explained below in more detail with reference to FIG. 15, performs the (temporary) deletion of obsolete files that have already been transferred to the remote repository. The terminal application 201 sends a request L51 to the terminal database 202 inquiring the status of the local data storage capacity. The terminal database sends a storage response L53 to the terminal application, which in step 651 analyzes the response according to the definitions. If some predetermined criteria are met, a selection step 653 follows, where items selected for deletion are identified, and this is further communicated to terminal database 202 by sending a delete command L55.

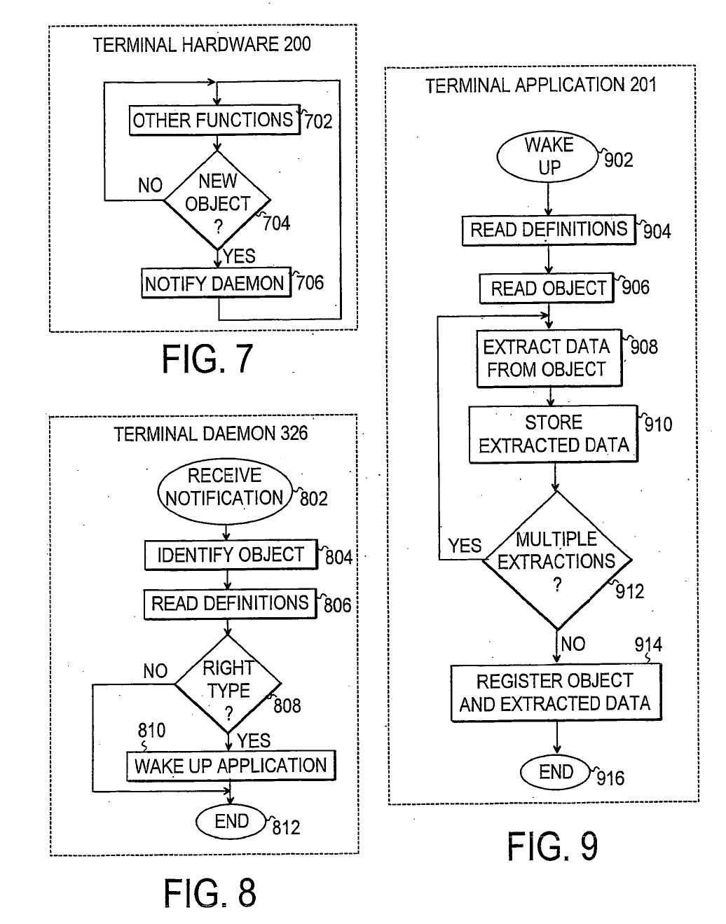

FIG. 7 shows the action logic of step 602 in cases where the functionality is implemented in the terminal hardware. The hardware performs (step 702) its other functions, after which the processing is interrupted in order to check (step 704) whether a new object has been acquired. If the result is that some new object has been acquired, the terminal daemon 326 is notified in step 706. After this the terminal hardware continues its normal operation. The checking step may be implemented, for example, by reserving some interruption of the mobile terminal CPU for a program performing the checking. Alternatively, a step 706 may be implemented in the storage means 202 of the mobile terminal in such a way that when the object register 380 receives a new item it performs the step 706 simultaneously. This can also be performed in the database accession block 362 or in the object generation block 366. The daemon may be notified when the block 362 accesses the database in the “create new object” mode, or when the object generation block is generating a new object.

FIG. 8 is a flow diagram of the terminal daemon 326. When the terminal daemon receives (step 802) a notification, it wakes up, i.e. it goes into an active state. Basically, this means that the priority or the given processor time of the application is increased, and/or the necessary program code is loaded into the memory from the storage means 202.

The first thing after receiving the notification is to identify (step 804) the object. For this purpose, the terminal daemon must either be informed about the kind of object, for example, by providing the wake-up message with the file type identifier or by checking the identifier by the terminal daemon itself. The identifier logic can be similar to that widely used by different computer operating systems (filename extensions or file headers), or the identifier may be selected to correspond, for example, to different applications of a Nokia phone

When the object has been identified, the next step 806 to be performed is to read definitions of the object type. The daemon may have a list of applicable analysis means and routines for specific object types. For example, digital images may be of interest to it, while stored short messages are not to be analyzed, and so on. Each object type may have multiple analysis steps to be performed, but this is not necessary. When an analysis application is installed in the terminal device, or when such a service is installed in the MD DB system so that some new sort of content may be analyzed, the terminal daemon is to be informed of this.

If the object is of such a type that there is a need to i) extract data from the object, ii) transfer it to the MD DB for analysis, or iii) simply transfer the object to the MD DB, the corresponding application is woken up (step 810). After this step the terminal daemon returns (step 812) to idle status, i.e. starts again to listen for possible notifications.

FIG. 9 is a flow diagram describing the actions of a terminal application 201. First, the application wakes up (step 902). This is preferably accompanied with reading definitions in step 904. The definitions may include preferences for the analysis task, for example, when a digital image is in question, i) whether optical character recognition is to be performed, ii) what data is going to be extracted, and iii) whether the position of the mobile station is to be found out with respect to the analysis. This kind of setting information may be incorporated in the definitions table or file. After reading the definitions, the object is read in step 906 into the terminal memory.

Data extraction is performed (step 908) for the object in accordance with the definitions. As already stated, this includes the detection of relationships with other personal objects. In the next step 910 the extracted data is stored in the extracted data block 382 of the storage means 202. Then, in step 912 it is checked whether or not more extraction analysis is to be performed on the object according to the definitions. In a positive case the control returns to step 908; in the opposite case the object and the extracted data are registered (step 912). Then the execution of the terminal application is ready for completion (step 916).

The registration step 914 includes notifying the upload registry 280 about the content acquired. This may be performed, for example, by sending a short message, a data packet, or some other suitable information carrier to the upload registry.

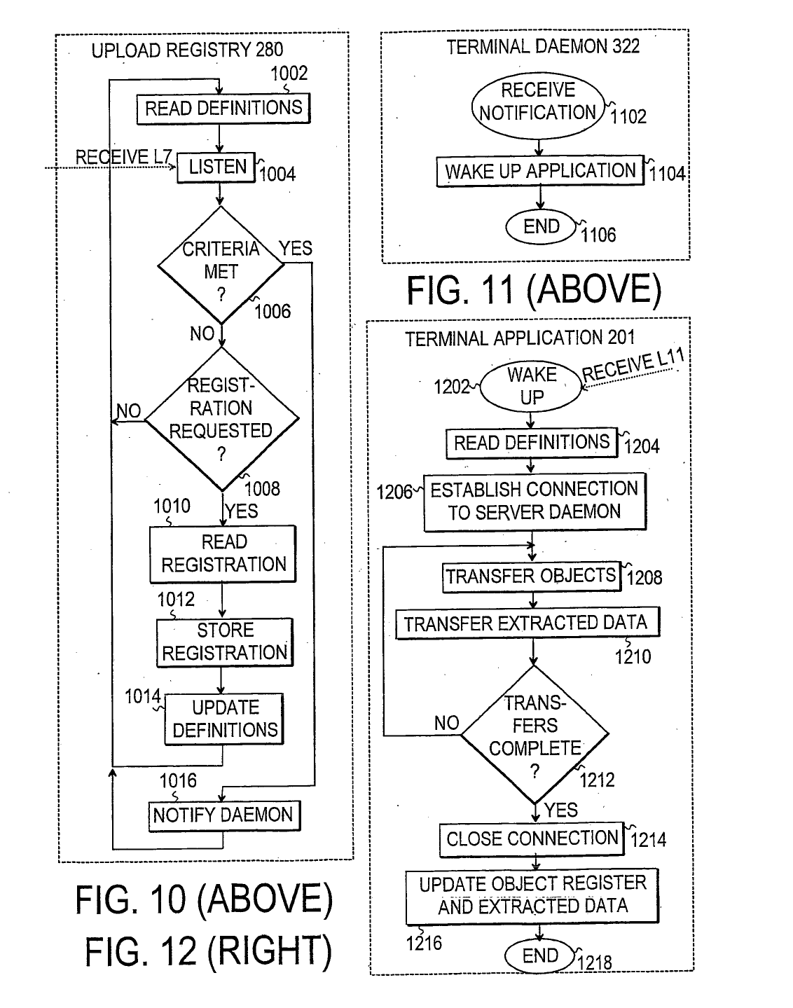

FIG. 10 is a flow diagram of the actions of the upload registry 280. In accordance with some aspects of the solution, the upload registry is favorably dedicated for several mobile terminals. When the upload registry favorably dedicated for several mobile terminals. When the upload registry application is initiated, the application reads the definitions in step 1002. Then the application starts listening and waits (step 1004) for interesting events. For example, a message L7 may be received. Basically, the upload registry has some conditions whose fulfillment it is monitoring. If there are already some registered objects, the listening may involve checking the system time, checking the network traffic pricing parameters, etc. Or, altenatively, the application may just wait a predetermined period of time.

In step 1006 it is checked whether the predefined criteria are met. The criteria may include i) the transfer price, ii) the radio network utilization coefficient, iii) the location of the user, i.e. the data is transferred only if the user is roaming in the home PLMN of the user, iv) forced transfer, in which case the data is transferred without taking the other criteria into account, and v) any combination of the above.

If some criterion is met, the upload registry notifies the network reachable daemon 322 of the mobile terminal. After this step the upload registry is ready to serve the next client, i.e. return to step 1002. In some respects, it is very important that the registry is capable of serving virtually several (even thousands) of clients at the same time. The upload registry may be implemented, for example, using a computer running UNIX-like operation system, whereas the registry functionality may be implemented by CRON-like program in combination with some network reachable daemon that writes the registrations into a file, the system periodically checking the registrations and then performing operations if necessary. A registry implemented using a simple Intel Pentium III processor family (both are registered trademarks by Intel), for example, may easily handle thousands of users. This is usually not only a question of the processor, but also of the internal and external bandwidth.

If no criterion is met to initiate the transfer, then a check is made (step 1008) as to whether a registration has been requested. If no registration has been requested, the control is returned to step 1002. In the opposite case, the registration is read (step 1010), and stored (step 1012). The registration may be further analyzed if the definitions need to be updated. The definitions are updated (step 1014) when necessary. After this step the control is returned to the step 1002.

FIG. 11 illustrates the terminal daemon 322. The daemon receives a notification in step 1102, preferably from the upload registry and not from a hacker, checks the notification, and if it is in a predetermined form, i.e. if the optional password and originating number or source address are correct, it accepts it and then wakes up (step 1104) the corresponding transfer application 201. After this the terminal daemon returns to an idle status (step 1106), i.e. starts to wait for the next notification.

FIG. 12 is a diagram showing an example of a control flow of the terminal application 201. The terminal application is woken up in step 1202 after a notification message L11 from the terminal daemon 322 is received. The application reads the definitions (step 1204), possibly including any in the wake-up message which the daemon has passed to the application and any which may be originating from the upload registry and specifying, for example, i) the transfer mode, ii) the destination address, and iii) the possible tasks before transfering the data.

The terminal application 201 establishes (step 1206) a connection to the server daemon 402, which preferably is located in the MD DB server 240. After this the terminal application transfers to the MD DB daemon objects and extracted data (steps 1208 and 1210, respectively) . As soon as the transfer of the objects and extracted data has been completed, the application checks (step 1212) whether there is still something to be transferred, and if necessary returns to steps 1208 and 1210. This may be the case, for example, when the user is simultaneously using the terminal equipment for acquiring new personal content. When necessary the content recently acquired may be transferred as well. Finally, the terminal receives some feedback as to which data has been safely transferred into the MD DB server 240. It is also possible to include transactional mechanisms here that ensure an “all-or-nothing” behavior: either all objects are stored in the server DB or, if the storage of at least one object fails, no object that is part of the same transaction is stored.

After the transfer has been completed, the connection is closed (step 1214) and the object register 380 and extracted data 382 may be updated (step 1216) to indicate the contents that have been transferred. After this, the application 201 is ready with its tasks or execution is terminated (step 1218).

FIG. 13 is a flow chart illustrating an example of the operation of the server daemon 402. Firstly, the daemon receives (step 1302) a connection request from the MD application 334. It reads (step 1304) definitions associated with the current client and then opens the connection to the terminal application in step 1306. Preferably this is performed by accepting the connection request sent by the MD application, but the connection may be opened from the server as well. The objects and data are transferred in step 1308 in a manner corresponding to the scheme presented in FIG. 12. If the transfer has not been completed (as checked in step 1310) the connection is not closed, but further transfer is commenced in step 1308 until everything has been transferred. Then a receipt concerning all correctly transferred objects is issued to the terminal application, the connection is closed (step 1312), and the daemon opens (step 1314) another connection to the MD DB server 240 or the remote data repository 242, depending on the implementation. The objects and data are transferred (step 1316), and similarly, if there is something else to be transferred (this is checked in step 1318), the transfer step 1316 is repeated until everything has been transferred prior to closing the connection 1320; if the transactional mode has been activated, all changes are revoked as soon as one object cannot be stored. Then the service applications are notified in step 1322 before the server daemon goes (step 1324) into a sleep state. If the terminal application has requested this behavior, a message is sent to it that contains information about the identity and/or number of correctly stored objects; this behavior may also be implemented as part of one of the aforementioned service applications.

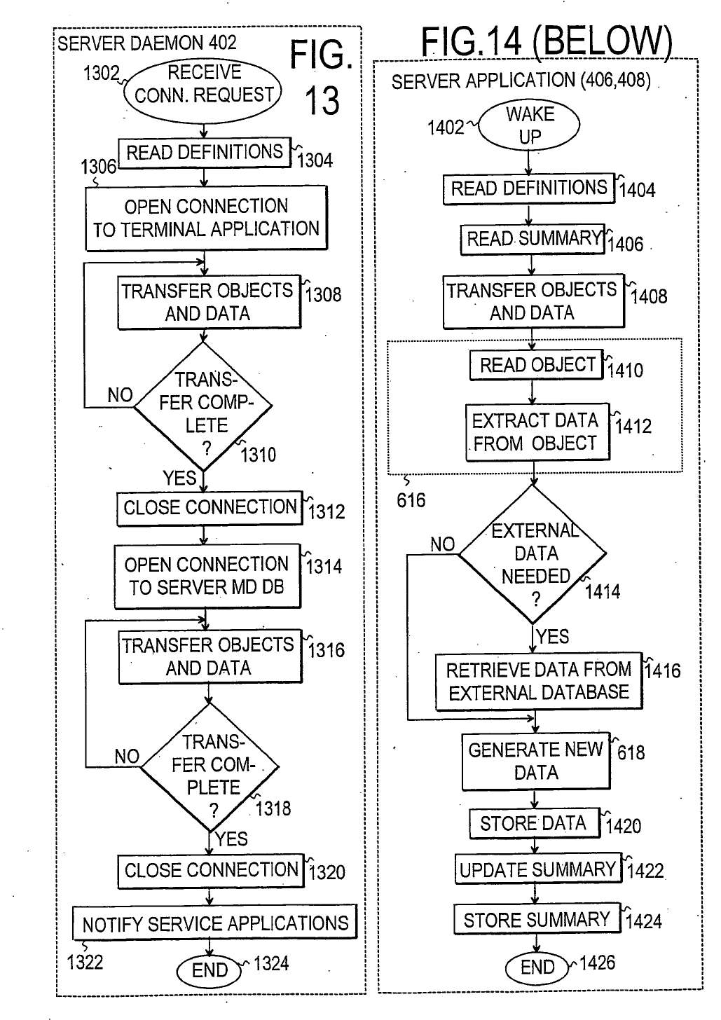

FIG. 14 presents the operation of the application in the MD DB server, or alternatively of a service application. The application is woken up in step 1402 after receiving a notification (message L21) from the server daemon 402. The application reads (step 1404) related definitions 404 from the definitions file and a summary 456 from the remote data repository.

After performing the previous steps, the application transfers (step 1408) objects from the object register 452 and the extracted data from extracted data part 458. One possibility for the analysis step 616 is that the transferred objects are read (step 1410) and data is extracted (step 1412) from said objects. The extraction of data means here extracting date and time information and/or other similar information, such as exposure parameters if the object is a digital image. If the object is a short message, a multi-media message, or something similar, the extracted information may also include information about the sender, such as the MSISDN or phonebook entry information. If the object is a video or audio clip, the information may include some other parameters, such as the duration of the clip, the bit rate, the copyright owner of the corresponding clip, etc.

Then it is decided (step 1414) whether or not external data is needed. If the purpose of the application is such that no external data is needed, but only new data is generated, the processing continues in step 618. In the opposite case, data is retrieved (step 1416) from an external database. Step 1416 may in practice mean several iterations of this step, so that also step 1414 is executed to check whether even more external data is considered necessary. The parameters for the fetching procedure may be selected from the extracted data, and if some privacy control mechanism is needed, the parameters can be checked in the MD DB system as to whether they contain any information interfering with user privacy. Basically, if the object is a digital image and the extracted information includes information such as the date and time of the image, and positioning information relating to the geographical location where the image was taken, this data can be used as parameters to search information from an Internet search engine, for example. The data may thus be used as parameters to a query, or in some other similar manner.

In step 618 new information is generated. This may include, for example, performing optical character or text recognition, and voice-to-text conversion. This information may again lead to the determination of new relationships between objects in the user's personal data. For example, if the object under consideration is a GPS measurement, a possible server application could find the street address of this GPS location; if this street address matches one of the addresses in the user's database of contacts, a match can be made between a contact entry and a GPS measurement and any image that the user has taken at this location, for example. Step 618 may also include performing some steps to merge the retrieved information and the already extracted data with the generated data. In some cases, this might mean the simple enlargement of available metadata, whereas in other cases some data might be discarded when there is more precise information available; e.g., the information “Southern Finland” might be discarded for an image if further analysis shows that it was taken at the “Olympic Stadium” in Helsinki.

When the new data has been generated, it is ready to be stored. This is performed in step 1420 and includes storing the data in the generated data part 458. Then the summary 456 has to be updated. This procedure is performed preferably in the application, which has read the summary in step 1406. The summary is updated to show the processes performed on the objects, to show the association between the objects and the generated and extracted data, and so on. The updated summary is stored (step 1424) in the summary 456 located in the data repository 242. Then the execution of the application is ended (step 1426).

FIG. 15 shows an example flowchart of how the deletion is performed in the mobile terminal. Preferably the deletion part is located in the MD application 334. First in step 1502 the definitions regarding the deletion of objects are read. The definitions may include classification of candidate object types to be deleted, some additional predetermined criteria, such as the required minimum age of the objects to be deleted, etc. The definitions may also include some limits for terminal memory storage (i.e. free space in storage means 202), such as upper and lower storage limits. Further, the definitions may include conditions related to these limits. The upper storage limit is the critical upper threshold for the terminal database capacity, the point at which the terminal is very soon going to run short of storage capacity. Then the forced transfer of some objects would be advantageous so that they can be locally deleted to create space in the terminal memory. The lower storage limit is the point at which it might already be preferable to delete at least some objects, but the situation is not considered a particularly critical one so that no forced transfer is performed.

The terminal application waits (step 1504), for example, a predetermined time defined in the definitions, prior to commencing any tasks. After the predefined period has elapsed, the application may read (step 1506) the object register and the analyzed data status. The application may request (step 1510) the storage status from the terminal database 202 (message L51). In step 1512 the application receives a storage response (message L53). The response is then analyzed, i.e. step 651 is performed.

If some objects have already been transferred (which is checked in step 1508), the application compares (step 1514) the storage response with the lower storage limit. If the limit has been reached, the objects to be deleted are selected (step 1516) and then deleted (step 653). In more detail, if the limit has been reached, possible candidates for deletion are determined based on upload status and access frequencies; if no such candidates, or not a sufficient number, can be determined, the operation skips forward back to step 1502. Otherwise it proceeds to step 653.

If the limit has not been reached, the operation returns to step 1502. The idea behind performing steps like this is that there is no need to delete the objects which are transferred before some part, say 30%, of the storage capacity of the mobile terminal has been used.

If it turns out in step 1508 that no objects have been transferred yet, the application compares (step 1532) the storage response with the upper storage limit. Here if it turns out that the upper limit has not been reached, the application returns to step 1502 and commences to wait after reading the definitions in order to detect possible updates or modifications. In the opposite case, however, a transfer is forced (step 1534), which may include waking up the transfer application 201 in the terminal by sending an emergency code which initiates an immediate transfer as described in FIG. 12 onward from step 1202. After the transfer has been completed, i.e. after step 1218, the execution returns to steps 1516 and 653, where the objects to be deleted are first selected and then deleted. In step 653 a message L55 is generated, which is then fed into the terminal database so that the files in the terminal database are erased. The actual implementation of this depends on the system used, but basically the principle that the files to be deleted are first selected and then deleted is applicable in general.

It is possible that the user modifies some attributes of the files so that the deletion of the items in question may be prohibited. Also, the user may have an option to confirm automatic deletion proposed by the application.

The enhanced storing of personal content can be integrated into the system in many ways. Generally, a remote repository belonging to the Media Diary framework can be any accessible database. The server-client system described may be implemented in various ways as well. The applications in the mobile terminal, the upload registry, and the remote repository may be implemented in different functional units as well, even in such a way that the order of the steps presented in the preferred embodiment differs. This does not change the idea of the present invention which is also applicable in such cases. For example, with regard to setting different definitions and defining the user interface, the service applications can be utilized either by using a service programming interface with any compatible programming language or by using any service user interface described by a generalized description language. Different kinds of adapters can be implemented for service integration.

One neat example of the invention reduced into practice is that the short messages, multimedia messages, or emails are transferred to the remote data repository. Some data, such as originator, recipient and subject of the message may be extracted, and even some other data, such as location information of the user may be stored. In this way the user might get some benefit of the idea that a specific message was received in a specific point in time, such as when the user was travelling by train from Cologne to Munich, Germany. This kind of metadata may enrich the personal content. Further, the data can be searched on the basis of the metadata. This approach also clearly helps the user to reduce the drawbacks of the finite terminal memory, for example.

Although the invention was described above with reference to the examples shown in the appended drawings, it is to be understood that the invention is not limited to these, but that it may be modified by those skilled in the art without departing from the scope and spirit of the invention.

1. A system for providing access to stored objects for mobile users, the system comprising
a mobile terminal provided with means for acquiring personal content, the mobile terminal being adapted to be in wireless communication with a telecommunications network,
storage means in the mobile terminal, the storage means being adapted to store the personal content acquired,
at least one remote data repository connected to the telecommunications system for storing personal content, whereby at least one of the repositories is assigned for the use of each mobile terminal,
means adapted to transfer selected personal content between the remote data repository and the storage means through said telecommunications, system, the means to include predetermined criteria, the fulfillment of which initiates said transfer,
the mobile terminal further provided with means for accessing stored personal content wherein i) the means are adapted to request an object including stored personal content from the storage means in the mobile terminal, ii) the storage means are adapted to respond with a predetermined return code if the requested object is not located in said storage means, and iii) the means are further arranged to request the object from the remote data repository if the return code indicates that the requested object is not located in said storage means.

2. A system according to claim 1, the system further comprising a server connected to said remote data repository, for managing said objects and information extracted and/or generated from said objects, the objects and information being the personal content stored in the remote data repository.

3. A system according to claim 2, the system further comprising
means in the server for updating the information related to said object to indicate that the object has been requested by the mobile terminal and
means for storing the updated information in the remote data repository.

4. A system according to claim 1, the system further comprising means in the mobile terminal for updating a register of the objects and/or extracted data stored at least at one point in time in the mobile terminal storage means.

5. A system according to claim 4, wherein said updating includes marking deleted and/or transferred objects and/or extracted data that has been transferred to the remote data repository.

6. A method for providing access to stored objects for mobile users, the method comprising
acquiring personal content in the mobile terminal adapted to be in wireless communication with a telecommunications network,
storing the personal content acquired in the mobile terminal,
assigning at least one remote data repository for the use of each mobile terminal, the repository being connected to the telecommunications system for storing personal content,
transfering selected personal content between the remote data repository and the mobile terminal through said telecommunications system, the means to include predetermined criteria, the fulfillment of which initiates said transfer,
accessing stored personal content from the mobile terminal by i) requesting an object including stored personal content, ii) receiving a predetermined return code if the requested object is not located in the mobile terminal, and iii) further requesting the object from the remote data repository if the return code indicates that the requested object is not located in the mobile terminal.

7. A method according to claim 6, the method further comprising the step of connecting a server to said remote data repository for managing objects and information extracted and/or generated from said objects, the objects and information forming the personal content stored in the remote data repository.

8. A method according to claim 7, the method further comprising the steps of
updating the information related to said object to indicate that the object has been requested by the mobile terminal and
storing the updated information in the remote data repository.

9. A method according to claim 6, the method further comprising the step of subsequently updating a register of the objects and/or extracted data stored in the mobile terminal storage means.

10. A method according to claim 9, wherein said updating includes marking deleted and/or transferred objects and/or extracted data that has been transferred to the remote data repository.
